(19) United States
(12) Patent Application Publication
(10) Pub. No.: US 2004/0117822 A1
(43) Pub. Date: Jun. 17, 2004

(54) Method and system for personal media program production in a media exchange network

(76) Inventors: Jeyhan Karaoguz, Irvine, CA (US); James Bennett, Laguna Beach, CA (US)

Correspondence Address: MCANDREWS HELD & MALLOY, LTD, 500 WEST MADISON STREET, SUITE 3400, CHICAGO, IL, 60661

(21) Appl. No.: 10/675,490

(22) Filed: Sep. 30, 2003

Related U.S. Application Data
(60) Provisional application No. 60/432,472, filed on Dec. 11, 2002.
(60) Provisional application No. 60/443,894, filed on Jan. 30, 2003.
(60) Provisional application No. 60/457,179, filed on Mar. 25, 2003.
(60) Provisional application No. 60/443,895, filed on Jan. 30, 2003.

(51) Int. Cl. G06F 13/00; H04N 5/445; G06F 3/00

(52) U.S. Cl. 725/37; 725/46

(57) ABSTRACT

Certain aspects of the invention may be found in a method and system for producing and delivering media content. The method may comprise establishing a personal television channel, modifying media content to produce a media program, and associating the produced media program with the established personal television channel. Metadata such as program metadata and/or primitive metadata associated with the media content may be acquired and edited. Accordingly, the acquired metadata associated with media content may be updated to reflect changes associated with modifying the media content. At least a portion of the produced media content may be displayed within the personal television channel.

### FIELD OF THE INVENTION

Certain embodiments of the present invention relate to media production. More specifically, certain embodiments of the invention relate to a method and system for personal media program production in a media exchange network.

### BACKGROUND OF THE INVENTION

Today, people in their homes and work offices may perform media content production in at least one of several existing methods. For example, tools such as a personal computer (PC) or workstation with sophisticated software packages are often used to create and edit media content and data. The media content produced often includes presentations, advertisements, reports, and other documentation. Video and audio may be created and/or edited using these tools as well. The media content and data may be edited and combined or overlaid with other media content and types.

The production of web pages that may be accessed by a PC or other media peripheral via the Internet is another example. Web page authoring tools allow a user to easily create web pages for themselves and others. Some of the functionality provided by the web page tools includes creating links to other sites on the Internet, inserting images and other types of graphics, and inserting video clips, audio clips and/or text.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

Certain aspects of the invention may be found in a method and system for producing and delivering media content. The method may comprise establishing a personal television channel, modifying media content to produce a media program, and associating the produced media program with the established personal television channel. Metadata such as program metadata and/or primitive metadata associated with the media content may be acquired and edited. Accordingly, the acquired metadata associated with media content may be updated to reflect changes associated with modification of the media content. At least a portion of the produced media content may be displayed within the personal television channel.

The method may also comprise the step of determining whether a media program comprises modified media content. If it is determined that the media program comprises modified media content, the media program may be processed based on metadata associated with the media content. The method may further include synchronizing the modified media content for presentation in the personal television channel.

Another embodiment of the invention may provide a machine-readable storage, having stored thereon, a computer program having at least one code section for providing personal media production and delivery. The at least one code section may be executable by a machine, thereby causing the machine to perform the steps as described above in the method for providing media production and delivery.

The system may comprise at least one processor that may be utilized to establish a personal television channel, modify media content to produce a media program, and associate the produced media program with the established personal television channel. The processor may comprise a computer processor, a media exchange software processor, a media peripheral processor, a storage processor, a media exchange server processor or a combination thereof. Metadata such as program metadata and/or primitive metadata associated with the media content may be acquired and edited by the processor. Accordingly, the acquired metadata associated with media content may be updated by the processor to reflect changes associated with the modifying. Under control of the processor, at least a portion of the produced media content may be displayed within the personal television channel.

The processor may also be adapted to determine whether a media program comprises modified media content. If it is determined that the media program comprises modified media content, the processor may process metadata associated with the media content. The processor may also be adapted to synchronize the modified media content for presentation in the personal television channel.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a block diagram of a media exchange network that may be utilized to support program production in accordance with an embodiment of the invention.

FIG. 1B is a diagram illustrating an embodiment of a television channel guide user interface or channel view that may be utilized to support personal media program production in a media exchange network, in accordance with various aspects of the present invention.

FIG. 1C is a flowchart illustrating an embodiment of a method to perform the personal media program production of FIG. 1B in a media exchange network, in accordance with various aspects of the present invention.

FIG. 2A is a diagram illustrating the generation of metadata during the personal media program production of FIG. 1B and FIG. 1C using a media exchange software platform, in accordance with various aspects of the present invention.

FIG. 2B is a diagram illustrating a media processing system (MPS), including the media exchange software platform of FIG. 2A, which may be utilized for performing the personal media program production of FIG. 1B and FIG. 1C and for generating the metadata of FIG. 2A, in accordance with various aspects of the present invention.

FIG. 3 is a schematic block diagram of a first exemplary media exchange network that may be utilized for exchanging, communicating and/or sharing digital media, data, and/or services in accordance with an embodiment of the present invention.

FIG. 4 is a schematic block diagram for performing personal media exchange over a second exemplary media exchange network in accordance with an embodiment of the present invention.

FIG. 5 is a schematic block diagram for performing third-party media exchange over a third exemplary media exchange network in accordance with an embodiment of the present invention.

FIG. 6 is an illustration of an exemplary television channel guide user interface in accordance with an embodiment of the present invention.

FIG. 7 is an exemplary illustration of several views of a television guide channel user interface of FIG. 4 in accordance with an embodiment of the present invention.

FIG. 8 is an exemplary illustration of a television guide channel user interface showing several options of a pushed media in accordance with an embodiment of the present invention.

FIG. 9A is an exemplary schematic block diagram of a media processing system (MPS) interfacing to media capture peripherals in accordance with an embodiment of the present invention.

FIG. 9B illustrates an alternative embodiment of a media processing system (MPS) in accordance with various aspects of the present invention.

FIG. 10 is a schematic block diagram of a personal computer and a media processing system interfacing to a server on a media exchange network in accordance with an embodiment of the present invention.

FIG. 11 is a schematic block diagram of a personal computer interfacing to personal media capture devices and remote media storage on a media exchange network in accordance with an embodiment of the present invention.

### DETAILED DESCRIPTION OF THE INVENTION

Certain embodiments of the invention may be found in a method and system for producing and delivering media content. Aspects of the method may comprise the steps of establishing a personal television channel, modifying media content to produce a media program, and associating the produced media program with the established personal television channel. Metadata such as program metadata and/or primitive metadata associated with the media content may be acquired and edited. Accordingly, the acquired metadata associated with media content may be updated to reflect changes associated with the modifying. At least a portion of the produced media content may be displayed within the personal television channel. A determination may be made as to whether a media program comprises modified media content. If it is determined that the media program comprises modified media content, the media program may be processed based on metadata that is associated with the media content. The method may further comprise the step of synchronizing the modified media content for presentation in the personal television channel.

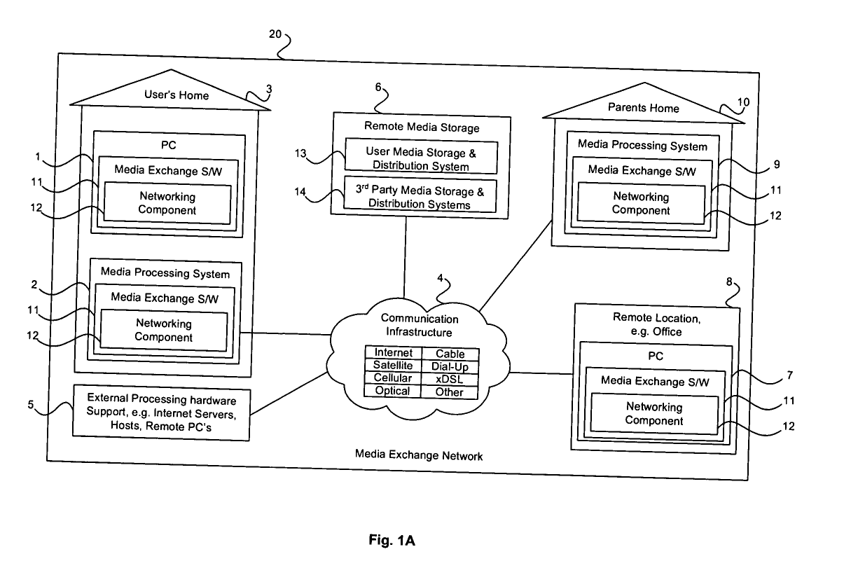

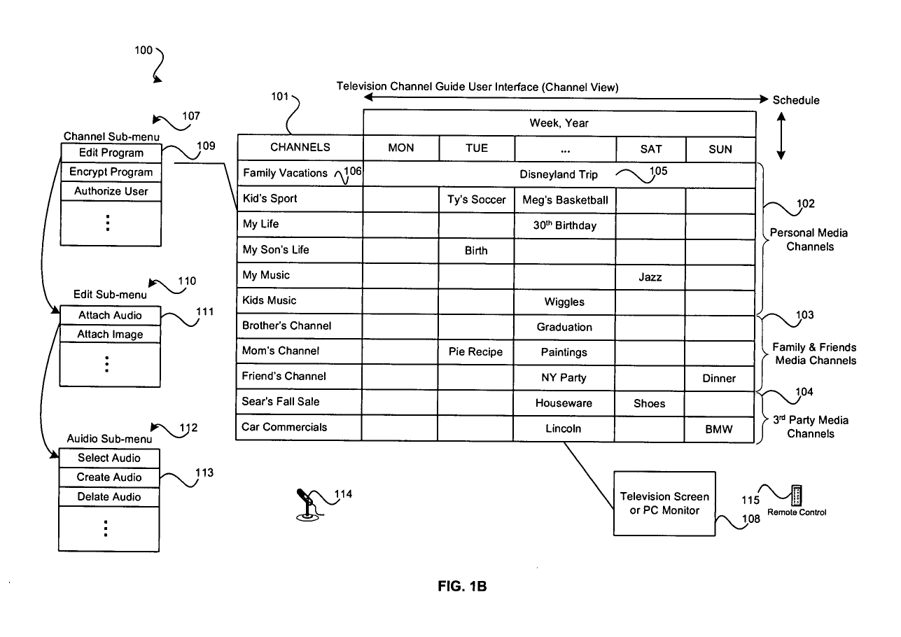

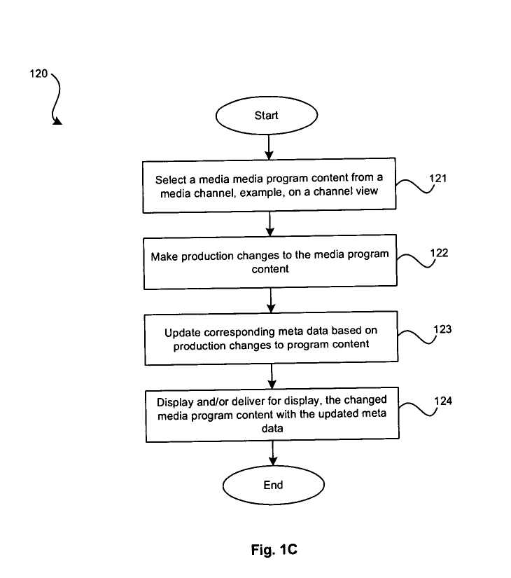

FIG. 1A is a block diagram of a media exchange network 20 that may be utilized to support program production in accordance with an embodiment of the invention. Referring to FIG. 1A, the media exchange network (MEN) of FIG. 1A may include a first PC 1 and a first media processing system (MPS) 2, which may be situated at a first location such as a user's home 303. The media exchange network 20 may also include a communication infrastructure 4, external processing hardware support 5 and remote media storage 6. A second PC 7 may be situated at a second location, which may be a remote location 8 such as an office. A third location such as a Parent's home 10 may include a media processing system 9. The media exchange network 20 may be a secure, closed network environment that may only be accessible to pre-defined users or subscribers and/or service providers. Notwithstanding, the invention may not be limited in this regard, and at least a portion of the network and/or services provided by the network may be publicly accessible.

The PC's in the media exchange network 20 may each include media exchange software and a networking component. In this regard, the PC 1 may include media exchange software 11 and networking component 12. The PC 7 may also include media exchange software 11 and networking component 12. The media processing systems in the media exchange network 20 may each include media exchange software and a networking component. In this regard, the media processing system 2 may include media exchange software 11 and networking component 12. Similarly, the media processing system 9 may include media exchange software 11 and networking component 12. The networking components 12 of PCs 1 and 7 and media processing systems 2 and 9 may be configured to provide networking connectivity to the communication infrastructure 4.

A media processing system may also comprise a set-top-box (STB), a PC, and/or a television with a media management system (MMS). A media management system may also be referred to as a media exchange software (MES) platform. Notwithstanding, a media management system may include a software platform operating on at least one processor that may provide certain functionality including user interface functionality, distributed storage functionality, networking functionality, and automatic control and monitoring of media peripheral devices. For example, a media management system may provide automatic control of media peripheral devices, automatic status monitoring of media peripheral devices, and inter-home media processing system routing selection. A media processing system may also be referred to as a media-box and/or an M-box. Any personal computer may indirectly access and/or control any media peripheral device in instances where the personal computer may include a media management system. Such access and/or control may be accomplished through various communication pathways via the media processing system or outside of the media processing system. A media processing system may also have the capability to automatically access and control any media peripheral device without user interaction and/or with user intervention. A personal computer (PC) may include media exchange software running on or being executed by the personal computer and may be referred to as a media processing system. The media processing system may also include a speech recognition engine that may be adapted to receive input speech and utilize the input speech control various functions of the media processing system.

Each of the elements or components of the network for communicating media or media exchange network may be identified by a network protocol address or other identifier which may include, but is not limited to, an Internet protocol (IP) address, a media access control (MAC) address and an electronic serial number (ESN). Examples of elements or components that may be identified by such addresses or identifiers may include media processing systems, media management systems, personal computers, media or content providers, media exchange software platforms and media peripherals.

The media exchange software platform 11 may provide functions and capabilities, which may include, but are not limited to media “push” capability, media “access” capability, media channel construction/selection, image sequence selection, text and voice overlay, channel and program naming and inter-home routing selection. The media exchange platform 11 may also provide authorship and media rights management, shared inter-home or inter-location media experience, billing services, and integrated television channel guide look-and-feel functionalities.

The external processing hardware support 5 may include at least one server such as a centralized internet server, a media exchange server, a peer-to-peer server, or a cable headend. Notwithstanding, functions provided by the server may alternatively be distributed over various hosts or remote PC's. The media exchange software platform 11 may also reside on the external processing hardware support server 5. The remote media storage 6 may include user media storage and distribution systems 13 and/or third party media storage and distribution systems 14.

The communication infrastructure 4 may include at least one of Internet infrastructure, satellite infrastructure, cable infrastructure, dial-up infrastructure, cellular infrastructure, xDSL infrastructure, optical infrastructure, or some other access and/or transport infrastructure. The communication infrastructure 4 may provide a common access and/or transport communication path for the first location or user's home 3, the second location or remote office location 8, the third location or parent's home 10 and the remote media storage 6. In this regard, the communication infrastructure 4 may provide access and/or transport communication path that may link users and service providers of the media exchange network 20.

FIG. 1B is a diagram illustrating an embodiment of a television channel guide user interface or channel view 100 that may be utilized to support personal media program production in a media exchange network, in accordance with various aspects of the present invention. Referring to FIG. 1B, the channel view 100 may include a table of media channels 101 such as personal media channels 102, friends' and family's media channels 103, and third (3^{rd}) party media channels 104. The media channels in the channel view 100 such as personal media channels 102, friends' and family's media channels 103, and third (3^{rd}) party media channels 104, may be generically referred to as customized media channels. Each of the channels displayed in the table of channels 103 may include scheduled media program content. The channel view 100 may be provided by a media exchange software (MES) platform such as MES 11 installed on PC 1 or a media processing system 2 on a media exchange network 20 of FIG. 1A. The channel view 100 may be presented to a user of the media exchange network and displayed on a PC monitor or television screen of the user's media processing system, for example. A personal computer (PC) comprising media exchange software running on or being executed by the personal computer, may also be referred to as a media processing system.

In one embodiment of the invention, a user may perform personal media program production of the media content contained within the channels 101 of the channel guide 100. In this regard, personal media program production may include performing various functions including editing of the raw media content such as video, images, audio, text, and data, for example. Additionally, personal media program production may also include augmenting raw media content with additional media content such as data, voice, text, images and video. Personal media program production may be provided by a media exchange software platform associated with a user's media processing system or PC on a media exchange network. For example, a user may currently have digital pictures of their “Disneyland Trip” 105 stored in a channel 106 which may be referred to as “Family Vacations” in the channel view 100. In this regard, the digital pictures may already be formatted as a slide show presentation and the user may now have a desire to add audio commentary to the existing slide show presentation.

Augmenting the media content may include, but is not limited to, editing the media content to include additional media content such as voice, video and/or data. For example, sound may be added to a video clip or an existing audio clip may be edited to provide additional audio enhancements. In this regard, an existing media content such as an audio clip may be compressed or converted to a different format. Additionally, an existing audio clip may be re-sampled at a different sample rate, for example. Enhancement may also include minimizing impairments or adding special effects to voice, video, data and/or text. Augmenting textural information may include rearranging or reformatting the text so that it may be viewed in different formats. This may include, translating the text to a different language, changing text attributes such as font type, font color and font size. Accordingly, augmenting the media content may include any type of modification and/or enhancement to the media content.

In order to add the audio commentary, the user may select the “Disneyland Trip” 105 media program content from the media channel 106, using a remote control 115 and/or other I/O device such as a mouse and/or keyboard. The selection of the media program content may cause a channel sub-menu 107 to be presented on, for example, the television screen or PC monitor 108. From the channel sub-menu 107, a user may next select an “Edit program” option 109. The selection of the “Edit program” option 109 may cause an “Edit” sub-menu 110 to be presented on the television or PC monitor 108. The user may then select the “Attach audio” option 111 from the “Edit” sub-menu 110 causing an “Audio” sub-menu 112 to be presented on the television screen or PC monitor 108.

Since the user may want to add their own commentary to the digital picture slide show presentation, the user may select a “Create audio” option 113 from the “Audio” sub-menu 112. The user may now speak into a microphone 114, for example, which may be coupled to or otherwise connected to the users media processing system or PC. Accordingly, the microphone may generate suitable audio commentary for each digital picture in the slide show presentation of the “Disneyland Trip” 105. Although not shown in the figures, other sub-menus may be provided that may allow the user to navigate among the digital pictures, thereby adding audio commentary to each of the digital pictures that the user may want to augment. Upon completion, the user may save the newly augmented “Disneyland Trip” 105 back to the “Family Vacations” channel 106.

In instances where a user may perform personal media program production on raw media content, such as digital pictures, an associated file comprising metadata information may also be updated as part of the media program production process. Metadata may be created by the media exchange software platform and may contain information that may describe various characteristics and attributes of the associated media content. Additionally, whenever a user may select media content for consumption, metadata related information may inform the media exchange software platform of the characteristics and attributes of the selected media content. Accordingly, the media exchange software platform may properly process the media content for consumption. Metadata information may be meaningful with regards to the raw media content that it may describe. For example, metadata may be utilized to inform a media exchange software platform of a title that should be placed in the channel view, options that should be presented in sub-menus, and the amount of time that may be allocated for queuing media content.

FIG. 1C is a flowchart illustrating an embodiment of a method 120 to perform the personal media program production of FIG. 1B in a media exchange network, in accordance with various aspects of the present invention. Referring to FIG. 1C, in step 121, media program content may be selected from a media channel on a channel view, for example. In step 122, production changes may be made to the selected media program content. In step 123, metadata associated with the media program content may be updated based on the production changes. In step 124, the modified media program content may be displayed or delivered for display along with the updated metadata.

The metadata may include various types of characteristic and attribute information, including but not limited to, a title or name of the media program content, a date and/or time the media program content was generated, created or otherwise modified and a history containing dates and authorship of production changes to the media program content. The metadata may also include navigation information and related sub-menus, file type and format and a media content type. Exemplary media content type may include, but is not limited to, MPEG, MPEG 1, MPEG 2, MP3, WMA, CD, TIFF, GIF, JPEG and raw text. Metadata may also include a file size of the media program content, a description of the media program content, queuing information, quality of service (QoS) attributes, security functions, authorization functions, encryption functions, encoding schemes, data rate, and compression schemes or algorithms. The queuing information may include a specified time for delivering media program content and associated costs. The quality of service attributes may include, for example, image resolution, number of pixels and image rendering information.

In accordance with an exemplary embodiment of the invention, in instances where a user may have added audio commentary such as in the “Disneyland Trip” media program content 105, the associated metadata file may be updated to reflect the new changes. In this regard, the metadata may provide an indication that the media program content 105 now includes digital images and audio. As a result, if the user pushes channel 106 “Family Vacations” to, for example, the user's mother, then the user's mother media processing system may examine the associated metadata file and recognize that the “Disneyland Trip” media program content 105 may include both digital images and audio. In instances where the user's mother may select the “Disneyland Trip” 105 within channel view, the user's mother media processing system may configure itself to process and play both the corresponding image information and audio information in a synchronized manner.

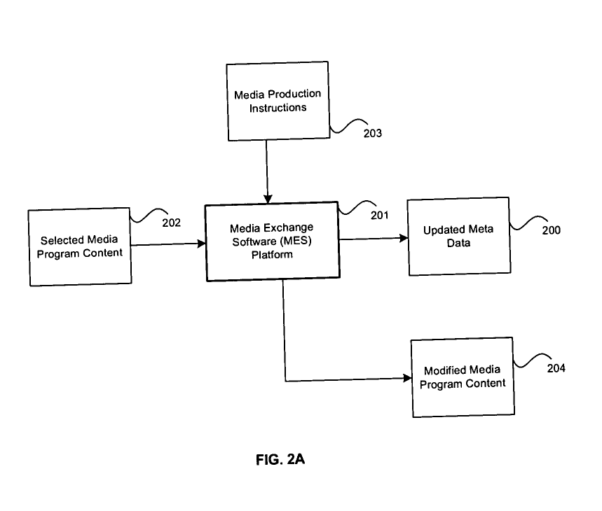

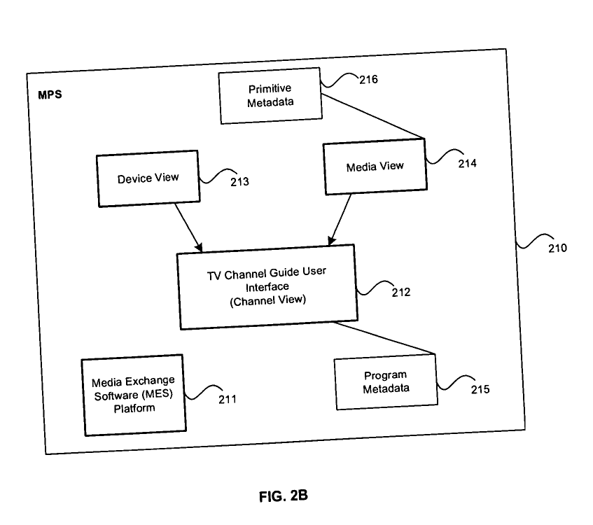

FIG. 2A is a diagram illustrating the generation of metadata during the personal media program production of FIG. 1B and FIG. 1C using a media exchange software platform 201, in accordance with various aspects of the present invention. Referring to FIG. 2A, the media exchange server platform 201 may receive as inputs, the selected media program content 202 and the production instructions 203. The media exchange platform 201 may operate on the media program content 202 according to the production instructions 203 and accordingly generate the modified media program content 204 and the associated, updated metadata 200.

The metadata 200 may be stored in a single file along with the media program content 204 and a clear delineation may be maintained in the single file between the metadata 200 and the media program content 204. Alternatively, the metadata 200 may be stored in a first file and the media program content 204 may be stored in a second file. Notwithstanding, the metadata 200 may include a pointer that may be utilized to access and/or index the corresponding media program content 204.

FIG. 2B is a diagram illustrating a media processing system (MPS) 210, including the media exchange software platform 211 of FIG. 2A, which may be utilized for performing the personal media program production of FIG. 1B and FIG. 1C and for generating the metadata of FIG. 2A, in accordance with various aspects of the present invention. The media exchange software platform 211 may provide a channel view 212, a device view 213 and/or a media view 214. The channel view 212, device view 213 and/or media view 214 may be displayed to a user on, for example, the television screen 108.

The channel view 212 may include a table of media channels and scheduled media program content. The device view 213 may include a table of devices on the media exchange network that the media processing system 210 may be connected to corresponding media content categories such as album titles and Internet radio stations, for example. The media view 214 may include a table of media content categories and specific media content such as individual songs, video clips, and images, for example.

Metadata may exist at the channel view level and may be associated with specific media program content, such as media content program metadata 215. However, metadata may also exist at the device view level and/or media view level. In this regard, the media view 214 may have primitive metadata 216 associated with it. The primitive metadata 216 may be a small subset of the media content program metadata 215. In other words, each media program content in the media view 214 may have its own primitive metadata which may include media program content file format, media content file size, and media program content file download or queuing time. However, in general, metadata may be generated at any level in the media exchange network, in accordance with an embodiment of the invention. Accordingly, metadata may be generated, prior to the creation of a device view and/or a media view or at the time the device view and/or media view are created. Additionally, metadata may be created whenever media program content for a corresponding device view and/or a media view gets transferred to a channel view.

The device view 213 may include raw media content and in certain instances, may not have any associated metadata. Also, the media program content metadata 215 for the channel view 212 or the primitive metadata 216 for the media view 214 may only point or refer to the actual raw media content which may be stored somewhere else on the media exchange network other than, for example, on the media processing system 210. The actual raw media program content may not yet have been queued and downloaded to the media processing system 210.

In another aspect of the invention, the primitive metadata 216 of the media view 214 may reference or otherwise point to a raw media content file stored at the remote media storage location 6 on the media exchange network 20 of FIG. 1A. The primitive metadata 216 may describe, for example, the file format, file size, and download time of the raw media content file. A user may select the raw media content file from the media view 214, thereby causing the raw media file to be downloaded to the user's media processing system 210. The user may then import or otherwise bring the raw media file into the channel view 212 as a media program content file and authorize pushing of the media program content file to certain family members on the media exchange network 20. As a result, the media program content file in the channel view 212 may have its own associated program metadata, which may include information such as channel information, authorization information and primitive metadata information.

In another aspect of the invention, metadata information associated with media program content may be viewable by a user. In this regard, a user may select a particular media program content and view at least a portion of the metadata information associated with the selected media program content. For example, it may be desirable to view the size of the media content file, the type of file, and the production history of the file. Accordingly, by selecting media program content, the size, type and production history may be viewed by a user.

A major challenge is to be able to transfer and share many different types of digital media, data, and services between one device/location and another with ease while being able to index, manage, and store the digital media and data.

For example, it is desirable to be able to distribute and store many types of digital media in a PC and/or television environment in a user-friendly manner without requiring many different types of software applications and/or unique and dedicated interfaces. Any networking issues or other technical issues should be transparent to the users. It is also desirable to take advantage of existing hardware infrastructure, as much as possible, when providing such capability.

In an embodiment of the present invention, a media exchange network is provided that enables many types of digital media, data, and/or services to be stored, indexed, viewed, searched for, pushed from one user to another, and requested by users, using a media guide user interface. The media exchange network also allows a user to construct personal media channels that comprise his personal digital media (e.g., captured digital pictures, digital video, digital audio, etc.), request that third-party media channels be constructed from third-party digital media, and access the media channels pushed to him by other users on the media exchange network.

PC's may be used but are not required to interface to the media exchange network for the purpose of exchanging digital media, data, and services. Instead, set-top-boxes or integrated MPS's (media processing systems) may be used with the media exchange network to perform all of the previously described media exchange functions using a remote control with a television screen.

Current set-top-boxes may be software enhanced to create a MPS that provides full media exchange network interfacing and functionality via a TV screen with a TV guide look-and-feel. PC's may be software enhanced as well and provide the same TV guide look-and-feel. Therefore, the media exchange network supports both PC's and MPS's in a similar manner. Alternatively, a fully integrated MPS may be designed from the ground up, having full MPS capability.

In the case of an MPS configuration, the user takes advantage of his remote control and TV screen to use the media exchange network. In the case of a PC configuration, the user takes advantage of his keyboard and/or mouse to use the media exchange network.

An MPS or enhanced PC is effectively a storage and distribution platform for the exchange of personal and third party digital media, data, and services as well as for bringing the conventional television channels to a user's home. An MPS and/or PC connects to the media exchange network via an existing communication infrastructure which may include cable, DSL, satellite, etc. The connection to the communication infrastructure may be hard-wired or wireless.

The media exchange network allows users to effectively become their own broadcasters from their own homes by creating their own media channels and pushing those media channels to other authorized users on the media exchange network, such as friends and family members.

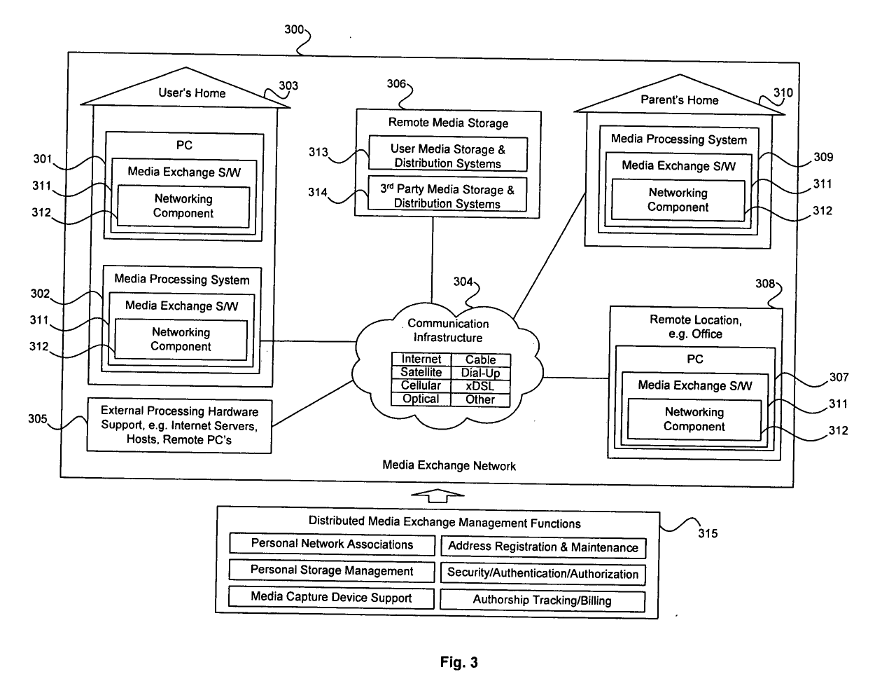

FIG. 3 comprises a media exchange network 300 for exchanging and sharing digital media, data, and services in accordance with an embodiment of the present invention. The media exchange network 300 is a secure, closed network environment that is only accessible to pre-defined users and service providers. The media exchange network of FIG. 3 comprises a first PC 301 and a first media processing system (MPS) 302 at a user's home 303, a communication infrastructure 304, external processing hardware support 305, remote media storage 306, a second PC 307 at a remote location 308 such as an office, and a second MPS 309 at a parent's home 310.

The PC's 301 and 307 and the MPS's 302 and 309 each include a media exchange software (MES) platform 311 and a networking component 312 for connectivity. The MES platform 311 provides multiple capabilities including media “push” capability, media “access” capability, media channel construction/selection, image sequence selection, text and voice overlay, channel and program naming, inter-home routing selection, authorship and media rights management, shared inter-home media experience, billing service, and an integrated media guide interface providing a TV channel guide look-and-feel.

The external processing hardware support 305 comprises at least one server such as a centralized internet server, a peer-to-peer server, or cable head end. The server may alternatively be distributed over various hosts or remote PC's. The MES platform 311 may also reside on the external processing hardware support server 305. The remote media storage 306 may comprise user media storage and distribution systems 313 and/or third party media storage and distribution systems 314.

The communication infrastructure 304 may comprise at least one of internet infrastructure, satellite infrastructure, cable infrastructure, dial-up infrastructure, cellular infrastructure, xDSL infrastructure, optical infrastructure, or some other infrastructure. The communication infrastructure 304 links the user's home 303, parent's home 310, remote media storage 306, and remote location office 308 to each other (i.e., the communication infrastructure 304 links all users and service providers of the media exchange network 300).

The various functions 315 of the media exchange network 300 comprise generating personal network associations, personal storage management, media capture device support, security/authentication/authorization support, authorship tracking and billing and address registration and maintenance. These media exchange management functions 315 may be distributed over various parts of the media exchange network 300. For example, the personal network associations and personal storage management functions may be integrated in the PC 301 at the user's home 303.

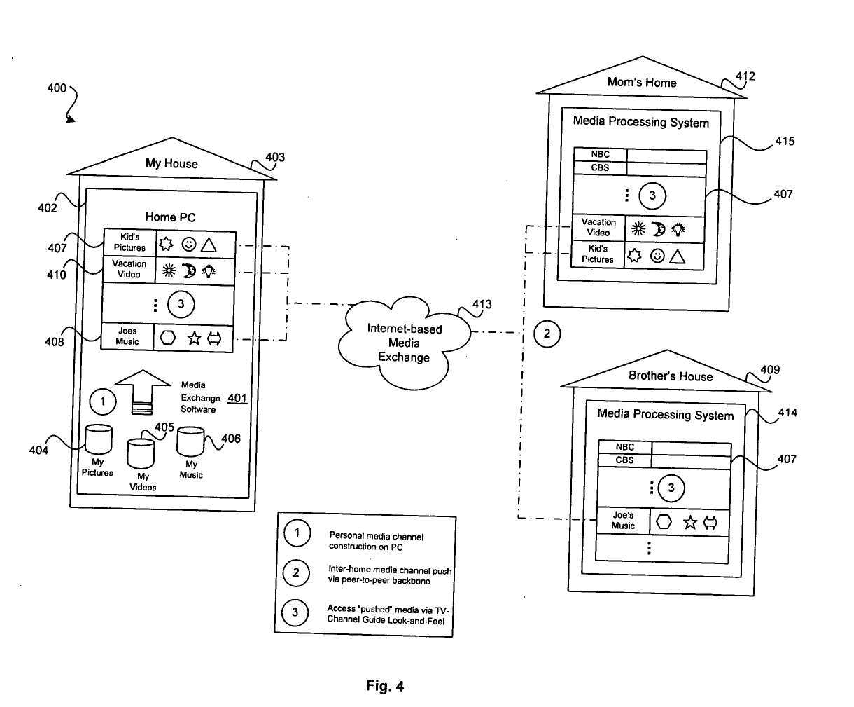

FIG. 4 illustrates an example of personal media exchange over a media exchange network 400 in accordance with an embodiment of the present invention. In step 1, the media exchange software (MES) platform 401 is used to construct personal media channels on a PC 402 by a user at “my house” 403. For example, with various media stored on the PC 402 such as digital pictures 404, videos 405, and music 406, the MES platform 401 allows the digital media to be organized by a user into several channels having a media guide user interface 407 on the PC 402.

In step 2, the user at “my house” 403 pushes a media channel 408 (e.g., “Joe's Music”) to “brother's house” 409 and pushes two media channels 410 and 411 (e.g., “Vacation Video” and “Kid's Pictures”) to “Mom's house” 412 via a peer-to-peer server 413 over the internet-based media exchange network 400. “Brother's house” 409 includes a first MPS 414 connected to the media exchange network 400. “Mom's house” 412 includes a second MPS 415 connected to the media exchange network 400. The MPS's 414 and 415 also provide a media guide user interface 407.

In step 3, brother and/or Mom access the pushed media channels via their respective media processing systems (MPS's) 414 and 415 using their respective MPS TV screens and remote controls.

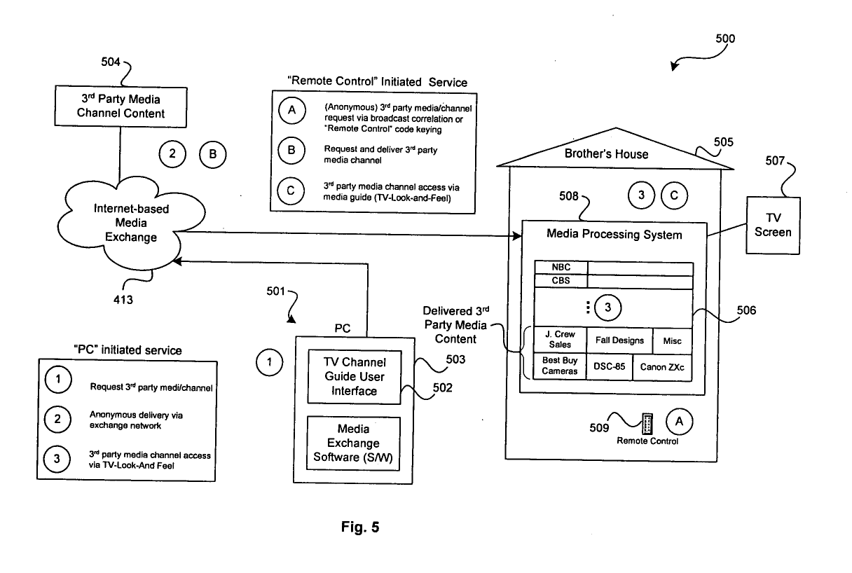

FIG. 5 illustrates an example of third-party media exchange over a media exchange network 500 in accordance with an embodiment of the present invention. In step 1, a PC-initiated third-party request is made by a first party 501 via an internet-based media exchange network 500 using a media guide user interface 502 on a PC 503. In step 2, an anonymous delivery of the requested third-party channel 504 is made to a second party 505 via the internet-based media exchange network 500. In step 3, the second party 505 accesses the third-party channel 504 using a media guide user interface 506 on a TV screen 507 that is integrated into an MPS 508.

Similarly, in step A, an MPS-initiated third-party request is made by a second party 505 via an internet-based media exchange network 500 using a media guide user interface 506 on a TV screen 507 using a remote control 509. The second party 505 may key in a code, using his remote control 509, that is correlated to a commercial or some other third party broadcast media. In step B, an anonymous delivery of the requested third-party channel 504 is made to a first party 501 via the internet-based media exchange network 500. In step C, the first party 501 accesses the third-party channel 504 using a media guide user interface 502 on a PC 503.

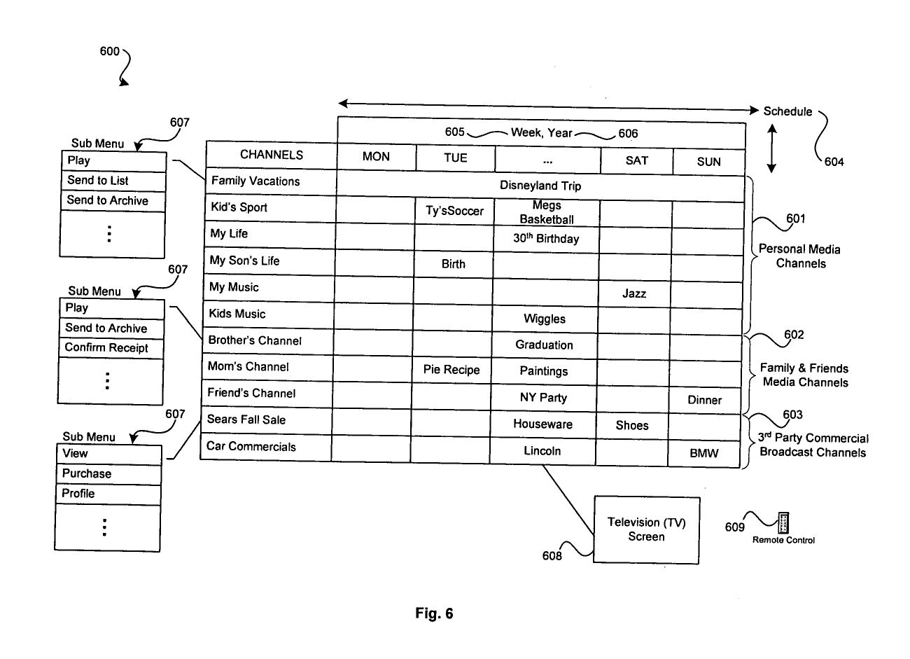

FIG. 6 illustrates a media guide user interface 600 in accordance with an embodiment of the present invention. The media guide user interface 600 may be displayed on a TV screen 608 and controlled by a remote control device 609. Also, the media guide user interface 600 may be displayed on a PC monitor and controlled by a keyboard or mouse.

The media guide user interface 600 may be configured not only for conventional TV channels but also for personal media channels 601 that are constructed by a user of a media exchange network, friend's and family's media channels 602 constructed by friends and family, and third party channels 603 that are constructed by third parties either upon request by a user of a media exchange network or based on a profile of a user.

The personal media channels 601 may include, for example, a “family vacations channel”, a “kid's sports channel”, a “my life channel”, a “son's life channel”, a “my music channel”, and a “kid's music channel”. The friends and family media channels 602 may include, for example, a “brother's channel”, a “Mom's channel”, and a “friend's channel”. The third party media channels 603 may include, for example, a “Sears Fall sale channel” and a “car commercials channel”.

Each media channel may correspond to a schedule 604 showing, for example, a week 605 and a year 606. For example, under the “kid's sports channel”, Ty's soccer game could be scheduled to be viewed on Tuesday of the current week 605 and current year 606. For each media channel, a sub-menu 607 allows for selection of certain control and access functions such as “play”, “send to list”, “send to archive”, “confirm receipt”, “view”, “purchase”, and “profile”.

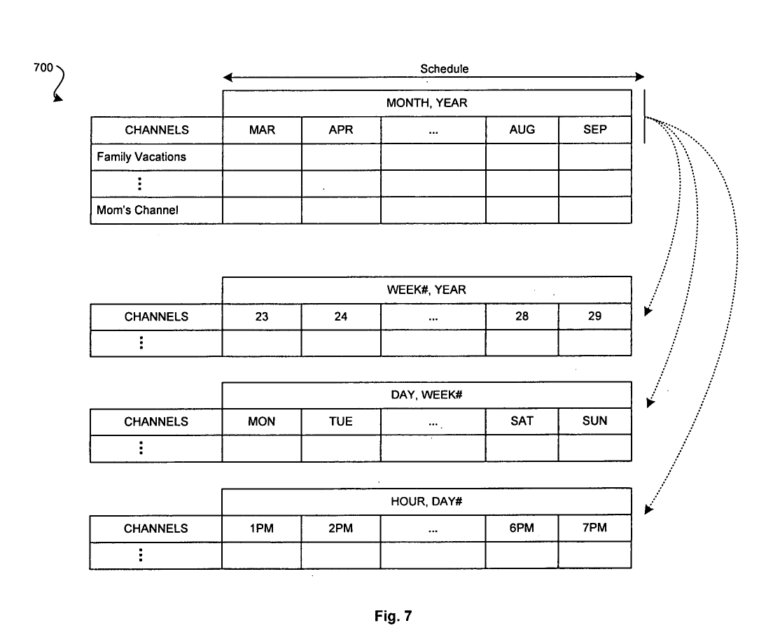

FIG. 7 illustrates possible multiple instantiations of a media guide user interface 700 in accordance with an embodiment of the present invention. The media guide user interface 700 may be viewed with a schedule having formats of, for example, “month, year”, “week#, year”, “day, week#”, or “hour, day”.

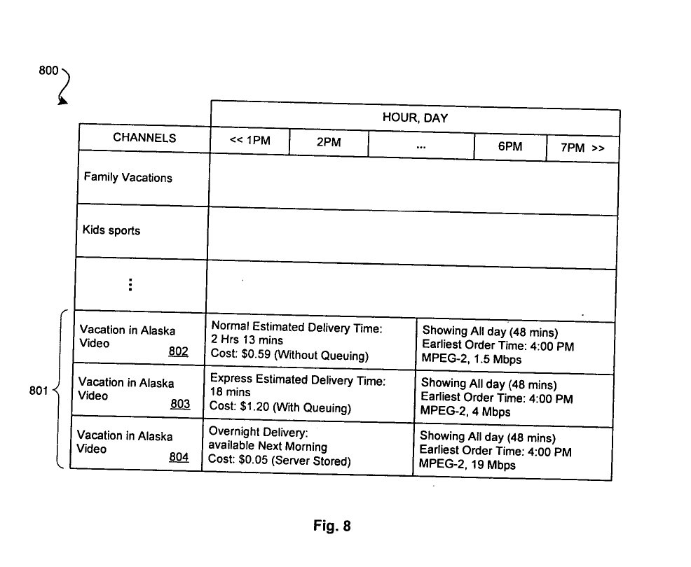

Referring to FIG. 8, a user of a media exchange network may push a media channel (e.g., “Vacation in Alaska Video”) to a friend who is on the same media exchange network. The media guide user interface 800 may give the friend several options 801 for how to accept and download the pushed media in accordance with an embodiment of the present invention.

For example, a first, most expensive option 803 may be “Express Delivery” which would deliver the pushed media to the friend in 18 minutes using queuing and cost $1.20, for example. The pushed media may be stored in a file in an MPEG 2 format that was recorded at a rate of 4 Mbps, for example. Queuing comprises buffering and delivering a previous part of the media and then buffering and delivering a next part of the media. For example, a first six minutes of the “Vacation in Alaska Video” may be buffered and delivered first, then a second six minutes may be buffered and delivered next, and so on until the entire media is delivered.

A second, less expensive option 802 may be “Normal Delivery” which would deliver the pushed media in 2 hours and 13 minutes without queuing and cost $0.59, for example. The pushed media may be stored in a file in an MPEG 2 format that was recorded at a rate of 1.5 Mbps, for example.

A third, least expensive option 804 may be “Overnight Delivery” which would deliver the pushed media by the next morning and cost only $0.05, for example. The pushed media may be stored in a file in an MPEG 2 format that was recorded at a rate of 19 Mbps and stored on a server, for example.

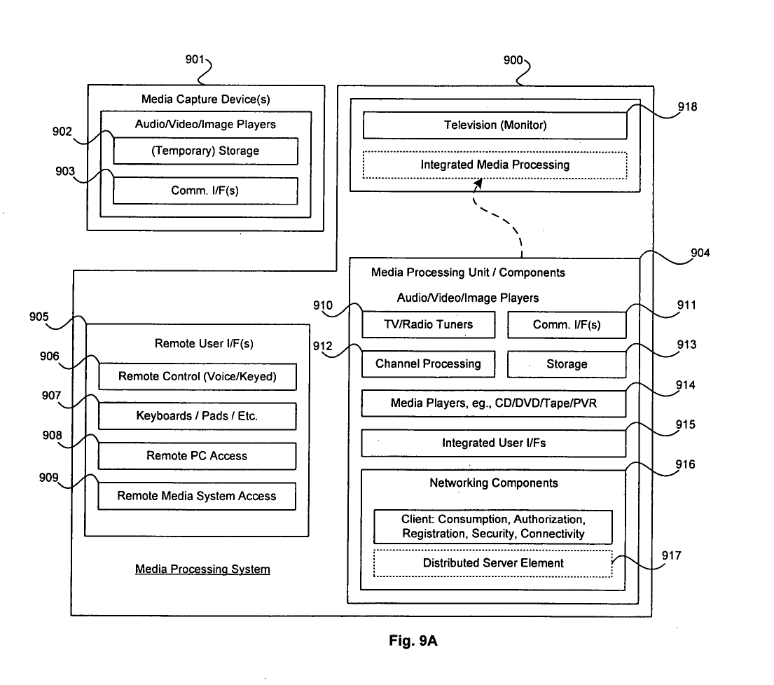

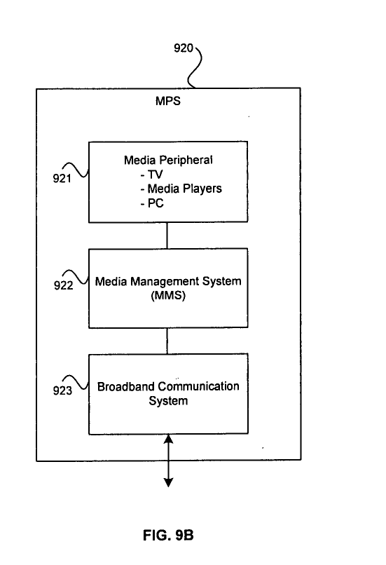

FIG. 9A illustrates the detailed elements of a media processing system (MPS) 900 and media capture devices 901 in accordance with an embodiment of the present invention. The media capture devices 901 may comprise audio, video, and image players, such as digital cameras, digital camcorders, and MP3 players, that each include a temporary storage area 902 and a communication interface 903 such as, for example, a USB interface or a wireless interface. The media capture devices 901 have the capability to interface to an MPS and a PC.

The MPS 900 comprises a media processing unit (MPU) 904, remote user interface(s) 905, and a TV screen 918 to provide integrated media processing capability and indirect user interface capability. The remote user interfaces 905 may comprise a voice or keyed remote control 906, keyboards and pads 907, a remote PC access interface 908, and a remote media system access interface 909 (i.e., providing access from another MPS).

The media processing unit (MPU) 904 comprises TV and radio tuners 910 for image and audio consumption, communications interfaces 911, channel processing 912 (creating, storing, indexing, viewing), storage 913, media players 914 (CD, DVD, Tape, PVR, MP3), an integrated user interface 915 (to provide a TV channel guide look-and-feel), networking components 916 to provide client functions such as consumption (billing), authorization (e.g., using digital certificates and digital ID's), registration, security, and connectivity. In an alternative embodiment of the present invention, the networking components 916 may include a distributed server element 917 that is part of a distributed server.

FIG. 9B illustrates an alternative embodiment of a media processing system (MPS) 920 in accordance with various aspects of the present invention. The MPS 920 is essentially an enhanced set-top-box for viewing and interacting with various user interfaces, media, data, and services that are available on the media exchange network using, for example, a remote control. The MPS 920 comprises a media peripheral 921, a MMS (media management system) 922, and a broadband communication interface 923.

The media peripheral 921 may include a TV (television), a PC (personal computer), and media players (e.g., a CD player, a DVD player, a tape player, and a MP3 player) for video, image, and audio consumption of broadcast and/or personal channels. The broadband communication interface 923 may include internal modems (e.g., a cable modem or DSL modem) or other interface devices in order to communicate with, for example, a cable or satellite headend.

The MMS 922 includes a software platform to provide functionality including media “push” capability, media “access” capability, media channel construction/selection, image sequence selection, text and voice overlay, channel and program naming, inter-home routing selection, authorship and media rights management, shared inter-home media experience, billing service, and a media guide user interface providing an integrated TV channel guide look-and-feel.

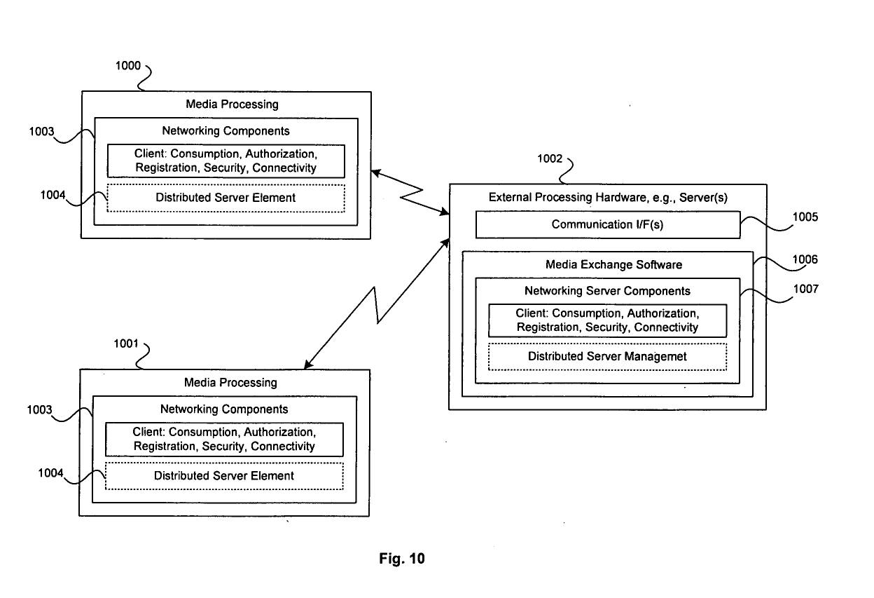

FIG. 10 illustrates connectivity between a PC 1000, an MPS 1001, and external processing hardware 1002 (e.g., a server) in accordance with an embodiment of the present invention. The PC 1000 and MPS 1001 include networking components 1003 to provide client functions such as consumption (billing), authorization, registration, security, and connectivity. Alternatively, the PC 1000 and MPS 1001 may include a distributed server element 1004 that is part of a distributed server.

The PC 1000 and MPS 1001 connect to the external processing hardware 1002 via wired or wireless connections. The external processing hardware 1002 comprises a distributed server or peer-to-peer server. The external processing hardware 1002 also comprises communication interfaces 1005 (e.g., cable interfaces, optical interfaces, etc.) and a media exchange software (MES) platform 1006. The MES platform 1006 in the external processing hardware 1002 allows for communication with the PC 1000 and MPS 1001 which may also use the same MES platform 1006. The external processing hardware 1002 also includes networking server components 1007 to provide the similar client functions such as consumption (billing), authorization, registration, security, and connectivity at the server side.

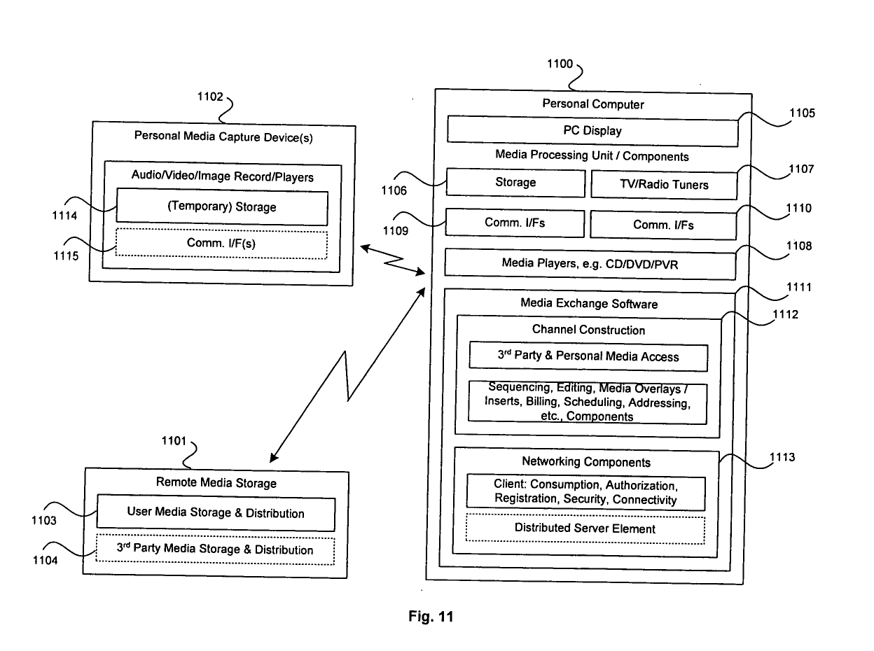

FIG. 11 illustrates connectivity between a PC 1100, remote media storage 1101, and personal media capture devices 1102 when the PC 1100 is used as the primary distributor of digital media such as in the case of PC-to-PC operation, in accordance with an embodiment of the present invention. The personal media capture devices 1102 and remote media storage 1101 connect to the PC 1100 via a wireless or wired connection. The remote media storage 1101 provides user media storage and distribution 1103 as well as third party media storage and distribution 1104. The personal media capture devices 1102 provide temporary storage 1114 and communication interfaces 1115.

Viewing is done using a PC monitor 1105 instead of a television screen. The PC 1100 may include storage 1106, TV/radio tuners 1107 for media consumption, media players 1108, and communication interfaces 1109 and user interfaces 1110 similar to those for the MPS of FIG. 9A. The PC 1100 includes a media exchange software (MES) platform 1111 that provides channel construction capability 1112 and networking capability 1113. The channel construction capability 1112 allows third party and personal media access, sequencing, editing, media overlays and inserts, billing, scheduling, and addressing.

In accordance with an embodiment of the invention, a system for producing or delivering media may comprise at least one processor that may be utilized to establish a personal television channel, modify media content to produce a media program, and associate the produced media program with the established personal television channel. The processor may comprise a computer processor, a media exchange software processor, a media peripheral processor, a storage processor, a media exchange server processor or a combination thereof. Metadata such as program metadata and/or primitive metadata associated with the media content may be acquired and edited by the processor. Accordingly, the acquired metadata associated with media content may be updated by the processor to reflect changes associated with modification of the media content. Under control of the processor, at least a portion of the produced media content may be displayed within the personal television channel. The processor may also determine whether a media program comprises modified media content. If it is determined that the media program comprises modified media content, the processor may process metadata associated with the media content. The processor may also be adapted to synchronize the modified media content for presentation in the personal television channel.

In another embodiment of the invention, a method for producing and delivering media may comprise establishing a customized channel for media or customized media channel between a first user and a first party using, for example, a display interface and receiving an input from the first user that selects at least one media program content. Depending on at least the received input, the media program content may be augmented and presented directly into the established customized media channel. While the media program content may be selected from a media view, a device view and/or a channel view, the augmented media program content may be presented in, for example, a channel view.

The invention may also include the step of acquiring metadata associated with the selected media program content and editing at least a portion of the acquired metadata. The metadata may include, but is not limited to, media program content metadata and/or primitive metadata. Notwithstanding, the acquired metadata associated with the media program content may be updated to reflect at least some of the changes associated with augmenting and/or editing the media program content. At least a portion of the augmented media program content corresponding to the updated metadata may be displayed, for example, on a television screen of a media processing system.

Another aspect of the invention may also comprise determining whether the selected media program content includes augmented media program content. If it is determined that the selected media program content includes augmented media program content, the media program content may be processed based on metadata associated with the augmented media program content. Notwithstanding, the presentation of the augmented media program content may be synchronized during, for example, playback or display, in the customized media channel.

Aspects of a system for producing and delivering media may also comprise at least one processor that may establish a customized media channel between a first user and a first party. The processor may receive an input from the first user that selects one or more media program content. Based on the input from the first user and/or another input, the media program content may be augmented and presented directly into the established customized media channel under control of the processor. The media program content may be selected from a media view, device view and/or channel view and the augmented media program content presented in, for example, a channel view with the aid of the processor. A display interface may be utilized to establish the customized media channel. The processor may comprise a computer processor, a media exchange software processor, a media peripheral processor, a storage processor, a media exchange server processor or a combination thereof. The channel view may generally be referred to as a channel guide and the media view may generally be referred to as a view or listing of media. Accordingly, the media view may be referred to as a media guide.

The processor may acquire metadata associated with the selected media program content and at least a portion of the acquired metadata edited by the processor. In this regard, the metadata may include, for example, media program content metadata and/or primitive metadata. The acquired metadata associated with the media program content may be updated by the processor to reflect at least a portion of the changes associated with augmenting and/or editing the media program content. In operation, the processor may cause at least some of the augmented media program content corresponding to the updated acquired metadata to be displayed, for example, on a television screen of a media processing system.

The processor may also be adapted to determine whether the selected media program content includes augmented media program content. In this regard, if the selected media program content includes augmented media program content, the processor may process the media program content based on metadata associated with the augmented media program content. Notwithstanding, the processor may synchronize the presentation of the augmented media program content during, for example, playback or display, in the customized media channel. In accordance with an embodiment of the invention, the at least one processor may be a computer processor, a media exchange software processor, a media peripheral processor, a storage processor, a media exchange server processor or any combination thereof.

Accordingly, the present invention may be realized in hardware, software, or a combination of hardware and software. The present invention may be realized in a centralized fashion in one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for producing and delivering media content, the method comprising:
establishing a personal television channel;
modifying media content to produce a media program; and
associating said produced media program with said established personal television channel.

2. The method according to claim 1, further comprising acquiring metadata associated with said media content.

3. The method according to claim 2, wherein said acquired metadata is at least one of program metadata and primitive metadata.

4. The method according to claim 2, further comprising editing said acquired metadata associated with said media content.

5. The method according to claim 2, further comprising updating said acquired metadata associated with media content to reflect at least a portion of changes associated with said modifying.

6. The method according to claim 5, further comprising displaying at least a portion of said produced media program.

7. The method according to claim 1, wherein said modifying further comprises augmenting and editing said media content.

8. The method according to claim 1, further comprising determining whether a media program comprises said modified media content.

9. The method according to claim 8, further comprising if said media program comprises said modified media content, processing said media program based on metadata associated with said modified media content.

10. The method according to claim 1, further comprising synchronizing said modified media content for presentation in said personal television channel.

11. A machine-readable storage having stored thereon, a computer program having at least one code section for producing and media content, the at least one code section being executable by a machine for causing the machine to perform steps comprising:
establishing a personal television channel;
modifying media content to produce a media program; and
associating said produced media program with said established personal television channel.

12. The machine-readable storage according to claim 11, further comprising code for acquiring metadata associated with said media content.

13. The machine-readable storage according to claim 12, wherein said acquired metadata is at least one of program metadata and primitive metadata.

14. The machine-readable storage according to claim 12, further comprising code for editing said acquired metadata associated with said media content.

15. The machine-readable storage according to claim 12, further comprising code for updating said acquired metadata associated with media content to reflect at least a portion of changes associated with said modifying.

16. The machine-readable storage according to claim 15, further comprising code that causes display of at least a portion of said produced media program.

17. The machine-readable storage according to claim 11, further comprising code for augmenting and editing said media content.

18. The machine-readable storage according to claim 11, further comprising code for determining whether a media program comprises said modified media content.

19. The machine-readable storage according to claim 18, further comprising code for processing said media program based on metadata associated with said modified media content, if said media program comprises said modified media content.

20. The machine-readable storage according to claim 11, further comprising code for synchronizing said modified media content for presentation in said personal television channel.

21. A system for producing and delivering media content, the system comprising:
at least one processor for establishing a personal television channel;
said processor modifies media content to produce a media program; and
said processor associates said produced media program with said established personal television channel.

22. The system according to claim 21, wherein said processor acquires metadata associated with said media content.

23. The system according to claim 22, wherein said acquired metadata is at least one of program metadata and primitive metadata.

24. The system according to claim 22, wherein said processor controls editing of said acquired metadata associated with said media content.

25. The system according to claim 22, wherein said processor updates said acquired metadata associated with media content to reflect at least a portion of changes associated with said modifying.

26. The system according to claim 25, wherein said processor causes display of at least a portion of said produced media program.

27. The system according to claim 21, wherein said processor augments and edits said media content.

28. The system according to claim 21, wherein said processor determines whether a media program comprises said modified media content.

29. The system according to claim 28, wherein said processor processes said media program based on metadata associated with said modified media content, if said media program comprises said modified media content.

30. The system according to claim 21, wherein said processor synchronizes said modified media content for presentation in said personal television channel.

31. The system according to claim 21, wherein said at least one processor is at least one of a computer processor, a media exchange software processor, a media peripheral processor, a storage processor and a media exchange server processor.
